(19) United States
(12) Patent Application Publication
(10) Pub. No.: US 2010/0189563 A1
(43) Pub. Date: Jul. 29, 2010

(54) PROPELLER FOR VESSELS

(76) Inventor: Pablo Alfonso GONZÁLEZ ABAL, Curras Tomiño (Pontevedra) (ES)

Correspondence Address: WENDEROTH, LIND & PONACK, L.L.P., 1030 15th Street, N.W.,, Suite 400 East, Washington, DC, 20005-1503, US

(21) Appl. No.: 12/693,538

(22) Filed: Jan. 26, 2010

(30) Foreign Application Priority Data
Jan. 27, 2009 (ES) PCT/ES2009/000039
Apr. 27, 2009 (ES) U200900787

(51) Int. Cl. B64C 11/10; B63H 1/20

(52) U.S. Cl. 416/219 R

(57) ABSTRACT

The present invention refers to a fixed pitch type propeller for vessels, fitted with exchangeable blades and having a central core unit that can be coupled to the transmission receiving the movement from the corresponding engine, and a plurality of blades that surround it in an equiangular distribution and are affixed to the central core; said core (1) has a prism-like configuration with as many faces as blades (2), each of its lateral faces having a groove 6 that ends in a narrowed mouth opening, while the inner ends of blades 2 are each topped by a header (4) that can be coupled to one of the lateral faces of the core unit (1) and fitted midway with a rib (7) that is complementary to the groove (6). The invention also provides means for axial immobilization (3-8) of the headers (4) of the blades respective to the core unit (1).

### OBJECT OF THE INVENTION

The present invention refers to a propeller of the type used to motorized water going vessels and which diameter is between 1,250 and 7,500 mm, as is the custom.

The object of the invention is to obtain a propeller with exchangeable blades that are affixed to the core unit without screws, thus eliminating the tensions usually located around said screws, while at the same time increasing the robustness of the whole set and save assembly and disassembly times associated costs. The present invention decreases the number of components of the set, making it simpler and more compact.

The present invention belongs in the naval industry field, and more particularly in the machinery and accessories for motorizing vessels and/or naval propulsion category.

### BACKGROUND OF THE INVENTION

Customary, propellers, and more specifically fixed pitch propellers with exchangeable blades are configured by functionally combining a core, several radial blades and their affixing elements. Through said core the propeller receives the movement facilitated by the corresponding transmission actuated by the corresponding engine. The blades are assembled onto said core distributed around its periphery in a regular and equidistantly angular fashion.

The state of the art in terms of how blades are affixed to the propeller's core is, to date, to use screws are affixing elements. This method generates the following essential problems:
Localized tensions are generated around the through holes made for the screws when these are tightened.
The blades are weakened by said through holes, necessary to affix the screws.
The process of assembling and disassembling the blades is then a slow and laborious process because it requires having to attach and remove a considerable number of screws, a time consuming process that adds considerable costs.
Assembly and disassembly operations require numerous tools that are costly and in many instances hard to find.
Usually, the assembly screws have to be welded at the head to prevent losing them, adding another task and additional equipment that needs to be available at the assembly place.
In order to ensure the set is water tight, conventional propellers require, in many cases, rubber or similar joint unions to prevent any liquid from entering the set from the outside through the orifices, again adding structural complexity and extending assembly and disassembly time.

### DESCRIPTION OF THE INVENTION

The propeller object of the invention solves, in a fully satisfactory manner, the problems stated above.

More specifically and to said effect, the main characteristics of said propeller, while maintaining the basic structure of having a central core from which blades emerge radially outward, focuses on the fact that the blades are not affixed to the core by means of screws, but by a tongue and groove coupling mechanism that confers a prism-like configuration to the core, which has a number of faces that coincide with the number of blades comprising the propeller set (usually, and preferably four), by incorporating in each of said lateral faces longitudinal guides to which the tongue and groove coupling mechanism will be installed by means of a longitudinal slider element. The blades are affixed to the set by means of a complementary rib that fits into said groove.

Said grooves comes to a close at the end opposite to that of the coupling by means of a flange that doubles as end element for the blade assembly, that will subsequently remain perfectly affixed and fitted by means of a nut located on the opposite side.

Groove and rib may be configured in a dovetail joint type configuration, a “T” section joint or in any other type of joint that ensures the blades can operate in a stable manner.

In an alternative embodiment of the invention, grooves and ribs may have—depending on the particular configuration of the embodiment—a section that tapers gradually in the direction of said flange in order to attain perfect fit when assembling the blades on the core.

The assembly set described is complemented by a closing lid that is, once the blades are assembled onto the core unit, screwed to said core unit becoming then the axial retention means for said blades and easily disassembled.

Said tongue and groove type assembly, that is, an assembly that does not require screws, eliminates the aforementioned localized tensions that are normally found in the orifices made in the material to allow the screws to go through and that materialize when said screws are tightened.

The guides allow for quick blade change operations by simply taken out the nut that secures in place the assembly.

Because the whole set up does not have threaded orifices for fixing the blades, no harm can come to them as it is the case with conventional fixed pitch blades fitted with exchangeable blades.

The conical configuration or manner in which the guides converge allows for quick blade exchange operations by simply disassembling the closing lid, since in this case it suffices to move the blades in an upward direction to disassemble them.

Since 95% of propeller repair operations concern the blades, and a scarce 5% concern the core unit, and the propeller object of the invention is fitted with removable blades repairs will hardly be an issue, because the blades can simply be replaced rather than repaired.

If any of the blades was to be damaged, they can be replaced without the vessel having to go to dry dock or a shipyard for repairs, given the assembly and disassembly process is extremely simple and can be done while the vessel is afloat in the water.

The propeller can be assembled in situ with complete ease. This has a positive impact in transportation, storage and handling costs when compared to what is required by a standard monoblock fixed pitched propeller, since it can be assembled at the shipyard.

The design can be adapted to accommodate any affixing system to the vessel shaft (rotor slot, hydraulic channel, etc.) and the modification of choice will only affect the core unit, not the blades attachment system, which will be devoid of screw orifices in all cases.

### DESCRIPTION OF THE DRAWINGS

The following set of drawings is attached to complement the description of the invention and to provide better understanding of the characteristics of the invention according to one practical example of the preferred embodiment. This set of drawings is to be understood as an integrated part of said description, having illustrative rather than limiting character as shown below:

FIG. 1. Shows a plan view of the propeller object of the invention.

FIG. 2. Shows a perspective view of the same propeller and an exploded detail showing one of the blades in the process of being coupled to the core.

FIG. 3. Shows a section view according the A-A discontinued line shown in FIG. 1 with details extracted and enlarged to see more clearly certain parts of the propeller.

FIG. 4. Shows a plan view of the core unit to which the blades are assembled.

FIG. 5. Shows a side elevation view of the core unit portrayed in the previous figure.

FIG. 6. Shows a side view of one of the blades, including the corresponding header that serves as coupling element to the core as shown in FIGS. 4 and 5.

FIG. 7. Shows a detail of the rib in the header shown in the previous figure which function is to serve as the tongue element of the tongue and groove coupling element fitting the groove in the core unit as shown in FIG. 5.

FIG. 8. Shows a perspective of the parts of a dismantled propeller according to a second embodiment of the invention.

FIG. 9. Shows a side elevation view detail of the core of the propeller shown in FIG. 8.

FIG. 10. Shows a plan view of the same core shown in the previous figure.

### PREFERRED EMBODIMENT OF THE INVENTION

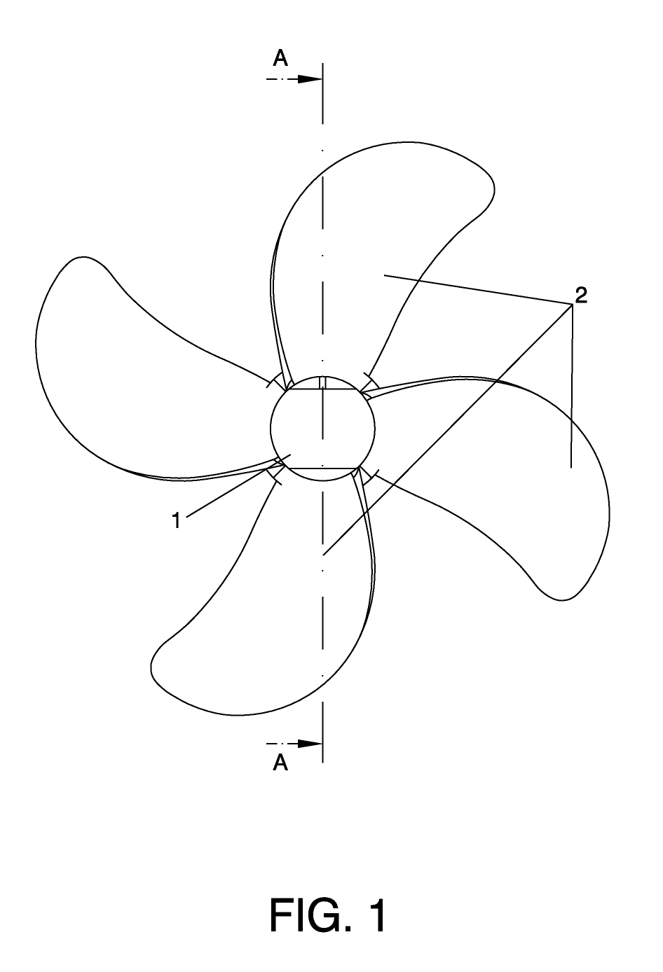

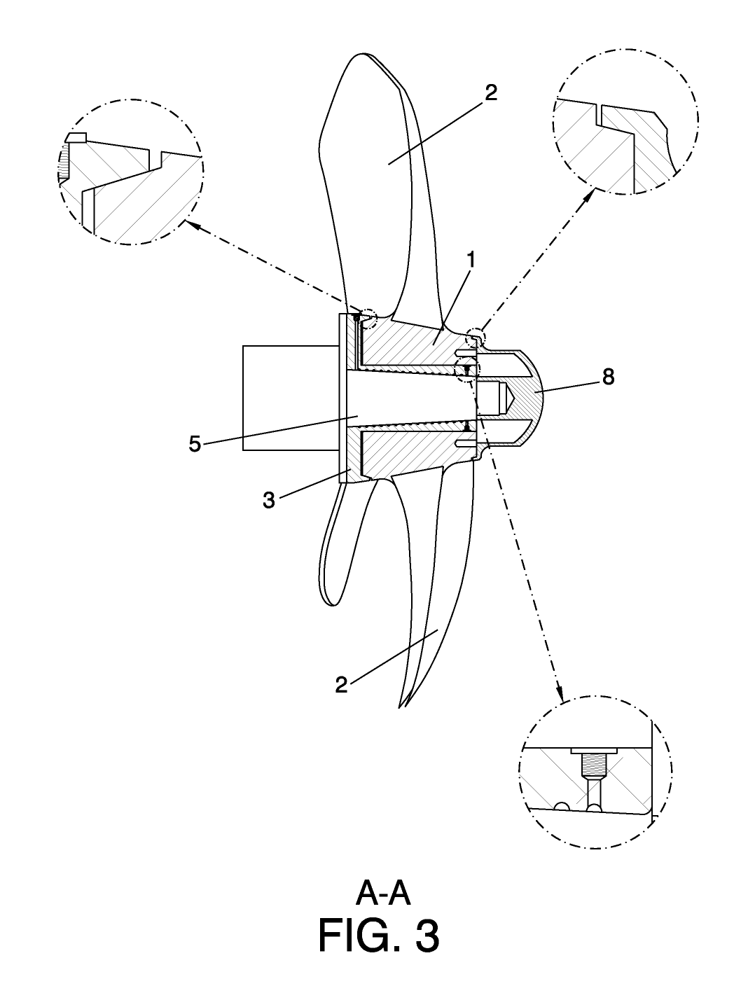

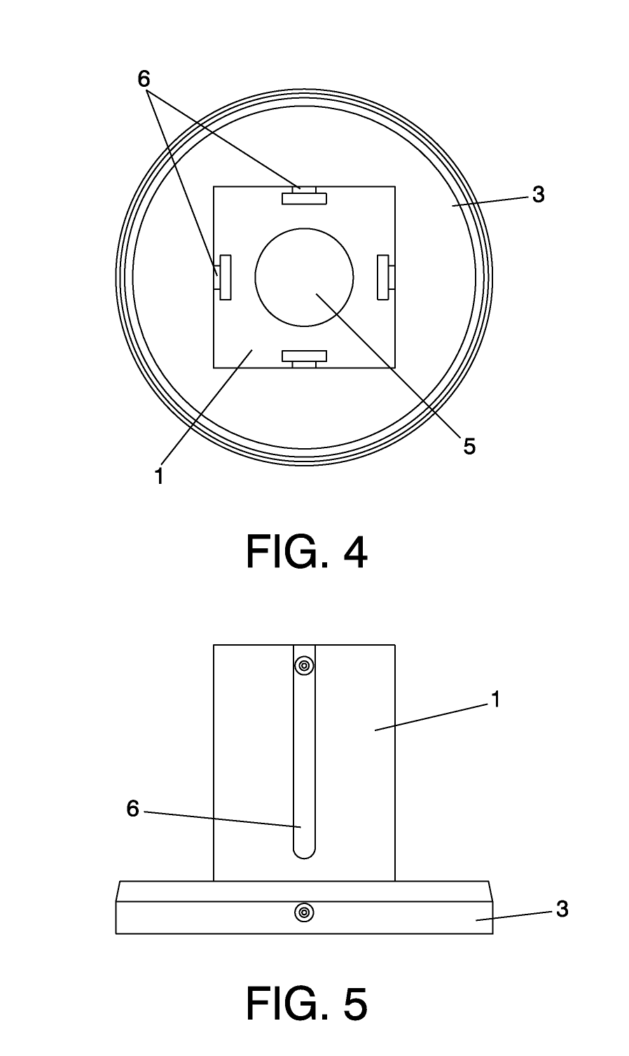

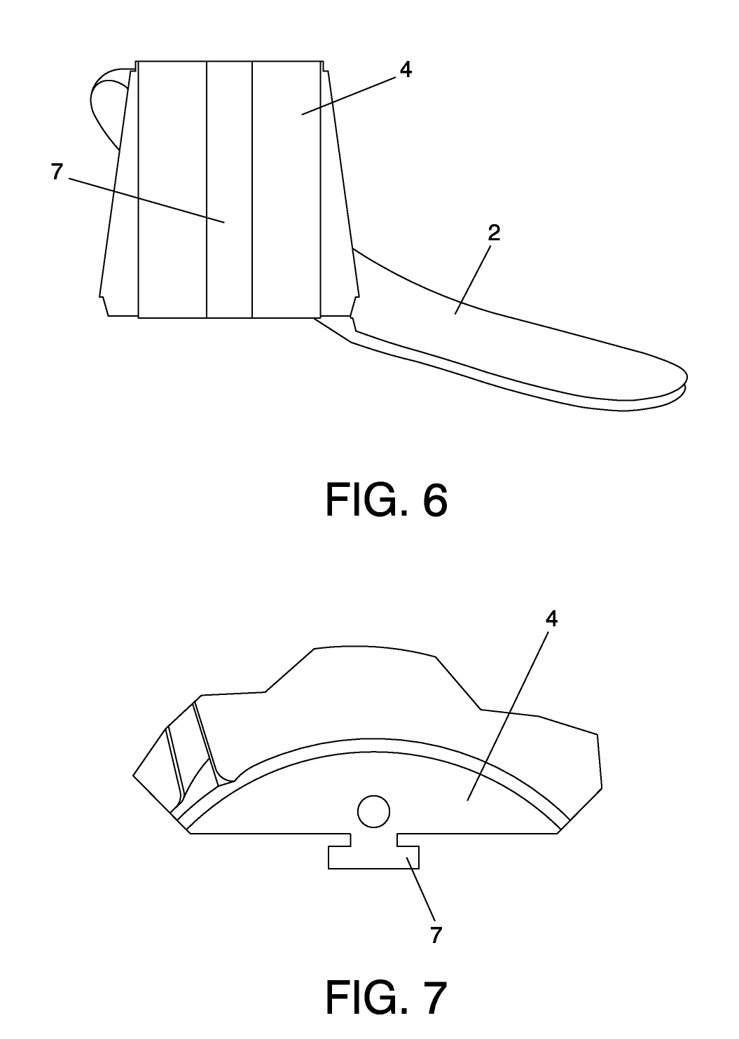

The figures attached, in particular FIGS. 1 to 7, show how the propeller object of the invention is configured from a core unit 1, which is shown in detail in FIGS. 5, 6 and 7, that adopts, for the purposes of the example of the practical embodiment chosen to illustrate the invention - which is the four blades 2 set up-, a prismatic-quadrangular configuration topped at one of its ends by a flange or circular perimetral expansion 3 that during the propeller assembly operation will coincide in shape and dimensions with the aforementioned core unit 1 and headers 4, through which said the blades 2 are affixed to said core unit.

Core unit 1 has an axial orifice 5, as it is the custom, to couple the propeller to the transmission system that receives the movement from the corresponding engine. An essential characteristic of the present invention is that each of the lateral faces of core unit 1 is fitted with a groove 6 running parallel to its axis an through the center of the face in question configured as a dovetail joint (or in a different configuration) intended to receive the complementary rib 7 each blade 2 has fitted at its header 4.

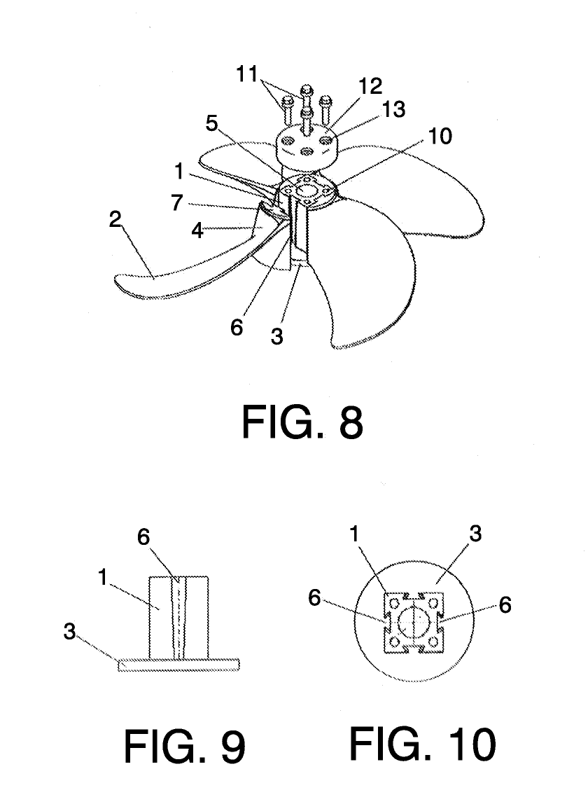

In the optional embodiment shown in FIGS. 8, 9 and 10, the section of grooves 6 tapers progressively and slightly towards the end, which is closed by flange 3, as is the case with complementary ribs 7. This particularity of the design is intended so a “wedge” type effect can be attained between the parts and the process of assembling blades 2 onto core 1 is made easy while ensuring perfect stability of the whole assembly in an extreme situation during which header 4 of blades 2 incides on flange 3 of core 1.

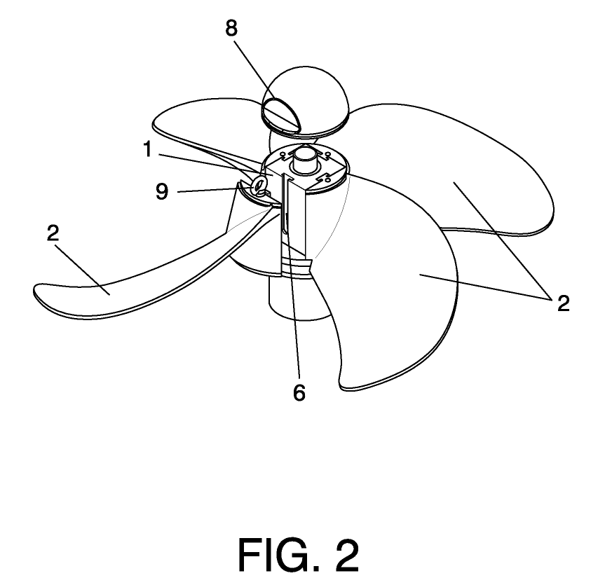

Although FIGS. 8 and 9 showcase a dovetail type joining mechanism, it is obvious that the structures can be coupled using other type of tongue and groove mechanisms such as “T” elements and in general any type of recesses 6 having a narrowed mouth opening such as those shown in FIGS. 2, 4 and 7.

FIGS. 1 to 7 show how a nut 8 is mounted on the base of the core unit 1 facing the flange acting as end 3, that is, on the base of the leading edge of blades 2, in such a manner that after the blades 2 are assembled said nut 8 is solidly joined to the vessel's shaft by means of the threading action, which compacts all the elements of set 1 and immobilizes headers 4 of said blades 2 in an axial sense in cooperation with flange 3.

According to the variation shown in FIG. 8, perimetral threaded orifices 10 are set on the leading edges of blades 2 that act as receptors of the respective through screws 11 going through the orifices 13 of a lid 12, in such a manner that after assembling blades 2 and lid 12 the latter is solidly joined to core 1 and headers 4 of said blades 2 are then immobilized in the axial sense in cooperation with flange 3.

Obviously, on header 4 of each blade 2 and on both sides of rib 7 there is a flat surface that provides a perfect fit for the corresponding lateral face of core unit 1.

Finally and optionally, each header 4 can have an orifice to fit an eye headed bolt 9 to facilitate removing blades 2 from core unit 1.

1. Propeller for vessels, of the fixed pitch type having exchangeable blades, a central core unit that can be coupled to the transmission receiving the movement from the corresponding engine, and a plurality of blades affixed to said core unit that surround it in an equiangular distribution, characterized in that the core unit (1) adopts a prism-like configuration having the same number of faces as blades (2), each lateral face fitted with a groove 6 that tapers into a narrowed mouth, while the internal end of each blade 2 is topped by a header (4) that can be coupled to one of the lateral faces of the core unit (1) through the rib (7) fitted in its midpoint and is complementary to the groove (6) so they together configure a longitudinally sliding tongue and groove joint, while also being fitted with means to immobilize axially (3-8) the headers (4) of the blades with respect to the core unit (1).

2. Propeller for vessels, according to claim 1, characterized in that both the narrowed mouth grooves (6) as the complementary ribs (7) fit together by means of a tongue and groove mechanism.

3. Propeller for vessels, according to the previous claims characterized in that the axial retention means designed for the blades (2) with respect to the core unit (1) comprise a flange (3) that is integral with the core unit (1) and tops one of its ends, thus configuring a limiting element preventing the rib (7) from penetrating the grooves (6) further, while cooperating with said flange (3) and on the opposite side of said flange (3) there is a nut (8, 12) that tightens it by threading it to the shaft of the vessel, conferring robustness and tightness to the assembly.

4. Propeller for vessels, according to the previous claims characterized in that the coupling mechanisms between grooves (6) and ribs (7) is configured as a dovetail joint or a “T”.

5. Propeller for vessels, according to previous claims 1 to 3 characterized in that the grooved coupling between grooves (6) and ribs (7) is a dovetail type joint.
